(19) United States
(12) Patent Application Publication
(10) Pub. No.: US 2010/0061313 A1
(43) Pub. Date: Mar. 11, 2010

(54) Method and apparatus for using remote station as backhaul in a coordinated manner

(76) Inventor: Edwin Park, San Diego, CA (US)

Correspondence Address: HENNEMAN & ASSOCIATES, PLC, 70 N. MAIN ST., THREE RIVERS, MI, 49093, US

(21) Appl. No.: 12/231,996

(22) Filed: Sep. 8, 2008

(51) Int. Cl. H04W 4/00

(52) U.S. Cl. 370/329

(57) ABSTRACT

There is provided a wireless system comprising a first base station, a second base station, a remote station capable of communicating with one of the first base station, the second base station and both first and second base stations and a wireless terminal coupled to the remote station for communication with one of the first base station, the second base station and both first and second base stations. The remote station includes a switch or multiplexor for switching communication between the first and second base stations. The schedule is predetermined centrally within the wireless network or locally by negotiation between base and remote stations.

### FIELD OF THE INVENTION

The present invention relates to methods and systems for extending coverage, increasing capacity, increasing throughput, and reducing interference, in wireless networks.

### BACKGROUND OF THE INVENTION

Referring to FIG. 1, there is illustrated a wireless network, simplified for ease of description. A typical wireless network 10 includes a plurality of base stations 12 for communications with a plurality of wireless terminals 14. The base stations is connected via a backhaul communications link 16 to a communications network 18

The base station 12 is a wireless communication station. A base station 12 has an associated backhaul 16 to move the data to and from the network 18. Base stations include wireless providers macro cell, Pico cell, and femto cells (previously known as access point base stations). Base stations can also refer to Wi-Fi access points. The backhaul 16 can be a phone line, DSL, cable modem, T-1, E1, another wireless link, or similar.

Current wireless networks allow terminals 14 to communicate (send/receive data) via access points or base stations. The terminals 14 of these systems can communicate with one or more of the access points or base stations.

Current networks are deployed with limitations that do not allow for ubiquitous coverage and the best QOS. Terrain, property rights, NIMBY, cost, etc prevent networks from being deployed so that the entire coverage area enjoy the highest data rate, lowest error rate, best QOS, or any other metric. The problems are manifested in dropped calls, reduced data rate, increased latency, etc. With enough degradation of service, terminals will reduce usage or drop the service or defect to another carrier that can better serve them.

One solution is to add remote stations 20 to extend the range of base station 12. The remote station 20 is also a wireless communication station. The remote station 20 can be a remote base station/access point, relay station, or range extender. It can also be a user equipment device that has required functionality. The functionality of a remote station is similar to a base station except it has reduced requirements and it does not have a direct backhaul, but can use a base station for the backhaul and other wireless devices for a backhaul.

A terminal 14 is the user equipment for the wireless connection. The terminal can be a mobile station, UE, data card, etc. A device 22 may be associated with the terminal 14 can be a computer, a phone, a PDA, television, or any device with a wireless connection.

The coverage area 24 and 28 is the range at which base station 12 or remote station 20, respectively, can communicate with the terminal 14 and 26, respectively, with the designed service requirement. The coverage area (24, 28) is a function of the transmission power, antenna pattern, antenna technology employed, modulation order, effective coding rate, data rate, and receiver performance, and so on. There are a couple of considerations. First, outside the coverage area, communication can still occur. It may have a lower data rate, higher error rate, lower QOS, etc. For example, SMS can easily occur at a coverage area far larger than the highest data rate. Though depicted as a circle/ellipsis, in actuality, the effective coverage area is not smooth. It is a function of the terrain, interference, and obstructions. The concept of “coverage area” applies to both uplink and downlink. The coverage area for the uplink and downlink usually are not symmetric due to the different nature of the downlink and the uplink design. Furthermore, the effective coverage area can be altered by techniques such as beam forming, sectoring, turning on/off antennas, moving antennas, shaping antennas, or alike.

In addition to coverage, there are other ways to improve coverage and reduce the interference. Other techniques include using different tones (OFDM) or using different timeslots for the access (TDD). Other techniques include changing downlink transmit power, coding rates, coding techniques, modulation order, length of cyclic prefix or symbol length (in OFDM). Furthermore, one can use multiple antenna techniques such as transmit diversity schemes.

The remote station 20 can be as simple as a base station 12 where the backhaul is not the typical T1, E1, fiber, or microwave link.

Furthermore, an environment where the remote station 20 is deployed is most likely a network where interference between the users 14 and 26 and between the remote station 20 and base station 12 with each other is prevalent. In such an environment, techniques to manage the interference allows the network to perform better (e.g. higher data rate, better QOS). To coordinate the technique(s) to manage the interference, in-band or out-of-band signalling can be used to coordinate among the neighboring remote station(s) and base station(s), or between the remote station(s)/base station(s) and some centralized control. To facilitate the communication a terminal (not necessarily the same waveform/protocol as the remote station/base station (which we will call the primary link)) can be connected to the remote station. The advantage of using a terminal (which is on the second link) would be the QOS/data rate of the coordination (secondary link) may be different than the QOS/data rate of the QOS/data rate of the primary ink. Moreover, the second link may be available sine the primary link will carry more data.

Because of limitation discussed in the previous section, every terminal cannot enjoy the same data rate at the best QOS. The typical problem is that a terminal is out of range of the base station that is available. Commonly, this is also known as a coverage problem. This situation is illustrated in simplified form in FIG. 2.

Currently, there are several ways to address the “out of range” problem. One would be to place another base station to cover the intended coverage area this is not currently covered (not shown). However, this is not always possible because unavailability of site for placement of a base station with backhaul support. Even if a base station can be installed, it may not justify the capital and operational cost of installing a new base station, especially when the new coverage area is small.

Another solution would be to place a repeater or relay (either passive or active). This is illustrated in FIG. 3 in simplified form. Repeaters or relays 20 have been used to expand the coverage area of conventional cellular systems. With such repeaters or relays, a terminal 26 that is out of range is able to communicate by the repeaters or relays 20. A repeater is a “A device that receives, amplifies and transmits the radiated or conducted RF carrier both in the down-link direction (from the base station to the mobile area) and in the up-link direction (from the mobile to the base station).” Quoted from 3GPP 25-106 version 8.02.

A repeater or relay 20 can be placed between the base station 12 and the intended coverage area that current base stations do not cover so that the repeater or relay can communicate with both the base station and the user. In doing so, coverage can be extended to cover the terminal. Repeaters and relays are typical less expensive and easier to install than a base station. Also, operation costs are significantly lower than base stations. Though the coverage area of the base station and the repeater or relays looks the same, this may or may not be the case in real life. The path the data takes from the terminal to the backhaul in the example above will be the base station to the repeater/relay to the terminal.

Also, remote stations can employ techniques such discussed earlier to (1) serve the terminal better or (2) reduce interference. The base station can also employ such techniques; however, it has more limitation since the base station is typically serving other/more terminals. The base station may not have the degree of freedom to employ these techniques without reducing the service to other terminals or increasing interference to others.

Typical remote stations 20, such as repeaters, have very little functionality: typically only retransmitting the signal to/from the base station. In effect, it extends the range of the signals. As such, the remote station 20 communicates with one base station 12. Typically, remote stations 20 are placed in locations that can better “see” (i.e. on the roof) the base station 12.

Another problem that occurs in this environment is interference. Typical communication systems employ a multiple access scheme on a shared resource (i.e. frequency). As shown in FIG. 4, as one base station 12a tries to cover a larger range or deliver a higher data rate, it may interfere with other terminals 27 or other base stations 12b and 12c. As shown in FIG. 4, there is a terminal 26 that is not currently covered by one of the many base stations 12 available. The “Previously out of range terminal” cannot see any of the deployed base station 12 prior to the remote station 20 being active. The terminal 26 is well within coverage area 28 of the remote station 20. However, after the remote station is deployed, the coverage area 28 of the remote station 20 may include another terminal 27 that is well served by the base station 12c. In this case, the “Interfered Terminal” is now penalized to cover the “Previously out of range terminal”. This is the interference problem.

To deal with both the “out of range” and “interference problem”, a translating repeater described in U.S. Pat. No. 6,718,160, Automatic Configuration of Backhaul and Groundlink Frequencies in a Wireless Repeater, can be used. This patent describes a repeater where one part of the link (terminal to repeater) is on one set of frequencies and another part of the link (repeater to the base station with backhaul) is on another set of frequencies. This presupposes that the network 10 has the extra frequencies available and the interference (i.e. noise) on those frequencies can be controlled on the extra frequencies. As the network 20 gets more crowded and the data rate increases, the frequencies available to the network are typically deployed so such additional frequencies are less available.

Another solution is provided in U.S. Pat. No. 7,321,571, In-Band Wireless Communications Network Backhaul. This patent addresses many of the issues concerning the backhaul and specifically for a CDMA2000 child station (as defined in the patent). This invention enables a child station (a.k.a. remote station) to allocate a channel(s) on the link between the terminal and the remote station mapping them to channel(s) to the link between the remote station and the base station. This patent does not address how to manage, minimize, or optimize the interference.

In a deployment of a network, the need to complete coverage, to allow for higher data rates, and to allow for a larger number of terminals, the number of base stations or access points has to be deployed at a higher density. One solution to this problem is to deploy femtocells. Femtocells are small base station that cover a smaller area are cheaper to deploy and cheaper to maintain. Femtocells connect to the core network via the internet. This connection can be through DSL or cable or whatever is available.

In areas where there are high densities of terminals, which use a fair amount of data, a system of femtocells may be deployed. Though femtocells are substantially cheaper than base stations to deploy, they may not be inexpensive enough. For example, if there is no internet (i.e. backhaul) access available, it may cost some infrastructure cost to bring an internet connection to the point. This may be true for building that was constructed before internet access was ubiquitous. A femtocell needs an internet access and power.

Power is ubiquitous in most locations. One solution utilizing current art is to install repeater. A repeater repeats the signal from a base station to the terminal and vice versa.

However, using a repeater alone in such a deployment has many limitations. FIG. 5 illustrates a typical coverage situation in a wireless network. In the portion of a wireless network shown in FIG. 5, two remotes (20a and 20b) are within coverage areas of 24a and 24b, respectively, of two base stations not shown in the figure. Remote stations 20a and 20b extend the coverage area to 28a and 28b, respectively. Thereby coverage is provided to terminal 42, which would otherwise be out of range. Since typical repeaters are associated with one base station, there is no means to balance the load as the traffic patterns change. Also, known repeaters have minimal ways to manage the interference it inherently causes. Hence, terminal 42, while now having coverage from both 28a and 28b, may also be subject to interference from the signals from the two sources. Similarly terminal 26, originally just inside of 24a and 24b, now has potential inference from 28a and 28b. The situation for terminal 40 is slightly different as it is within the coverage 24b of the second base station and 28b of the remote station 20b.

In the above figures to cover the terminal not originally covered by the base stations 12 alone, remote stations 20 (specifically repeaters) are needed. In FIG. 5, To cover the other nearby coverage holes, two additional stations 20a and 20b are needed due to the topology of the walls 30a and 30b. In placing the additional repeaters 20a and 20b, significant interference has been added. Much of the area nearby the repeaters are now covered by both of the original base stations and both of the uncoordinated repeaters.

Systems and methods disclosed herein provide a method and systems for improved coverage in a wireless network to obviate or mitigate at least some of the aforementioned disadvantages.

### SUMMARY OF THE INVENTION

An object of the present invention is to provide improved method and apparatus for extending coverage, increasing capacity, increasing throughput, and reducing interference. in wireless networks.

In accordance with an aspect of the present invention there is provided a method of communicating with a wireless terminal in a wireless network comprising the steps of; establishing primary coverage by deploying a first plurality of base stations; expanding primary coverage into secondary coverage by deploying a second plurality of remote stations, each remote station capable of communicating with at least two of the base stations; one of the remote stations providing enhanced service to a wireless terminal by coupling to one or more of the base stations in dependent upon a schedule.

In accordance with another aspect of the present invention there is provided a remote station for communicating with more than one base station comprising: a first transceiver communicating with a terminal; a second transceiver having first and second communication modes for communicating with two base stations; means for changing the second transceiver between the first, second modes in dependence upon on a schedule; and a schedule based upon at least one of error rates measured, signal and noise, interference measurements, and capacity available.

In an embodiment of the present invention there is provided a wireless system comprising: a first base station; a second base station; a remote station capable of communicating with one of the first base station, the second base station and both first and second base stations; and a wireless terminal coupled to the remote station for communication with one of the first base station, the second base station and both first and second base stations.

In an embodiment of the invention the schedule is packet based.

In a preferred embodiment in a LTE/Wimax Femtocell deployment, a LTE/WiMax terminal (i.e. data card) can be used to provide the backhaul for the femtocell to create the remote station. In an LTE and WiMax, femtocell, the backhaul can be IP based. An LTE/WiMax terminal (i.e. data card) can take an IP connection. Therefore, a remote station can be created by connecting a femtocell to a terminal. Though frequency and protocol used by the terminal and the femtocell used on the remote station can be shared, they do not necessarily have to be the same.

The present invention has the following advantages:
a) A remote station (remote base station/access point, relay station or range extender) that can be, but not required to be, associated with a plurality of base station at the simultaneously and at different times.
b) Allows the scheduling, either predetermined or adaptively, for communications between the base station(s) and the remote station(s).
c) Provides for the mechanism to coordinate the scheduling.
d) Ways to reduce interference caused by the remote station(s) and base station(s). This is useful in environments where there are many remote stations and base station where their coverage areas can overlap.
e) Allows for the scheduling to reconfigure the remote station so to minimize hardware.
f) Allows for the simple creation of such remote stations.

Generally, embodiments of the present invention reduce the cost of the installation (fewer remote station), reduce interference, and allow many of the terminals additional throughput capabilities.

### BRIEF DESCRIPTION OF THE DRAWINGS

The present invention will be further understood from the following detailed description with reference to the drawings in which:

FIG. 1 illustrates in a block diagram a typical wireless communications system;

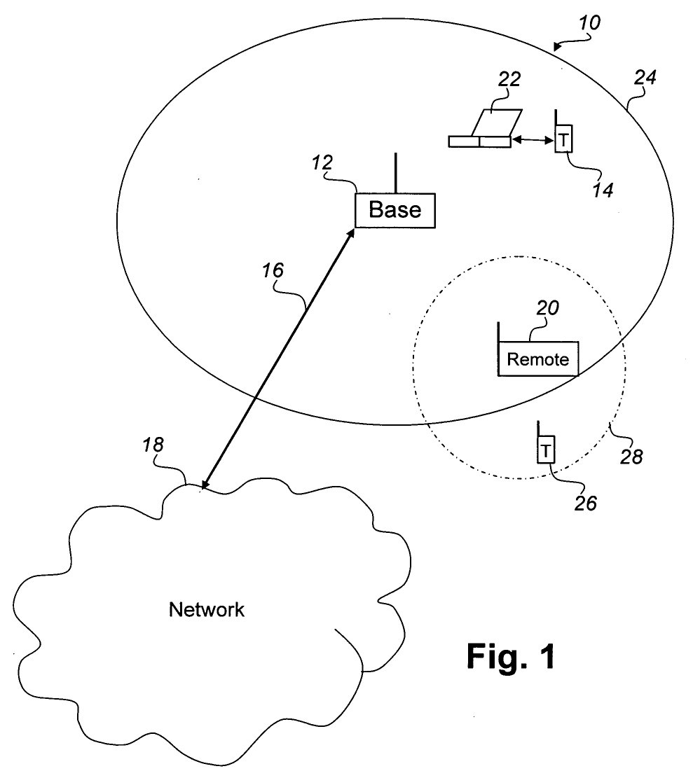

FIG. 2 illustrates an out of coverage situation in simplified form;

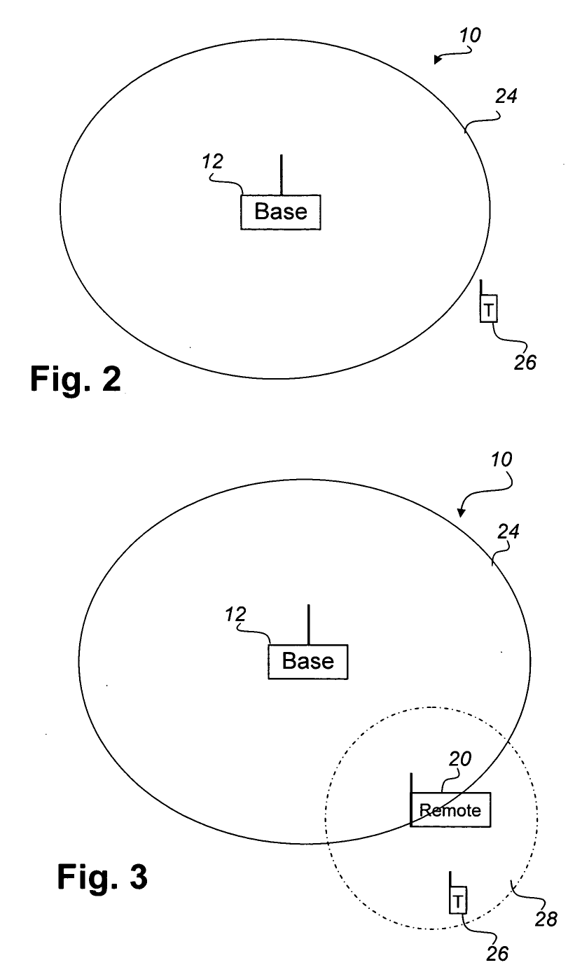

FIG. 3 illustrates a know solution to the out of coverage situation of FIG. 2;

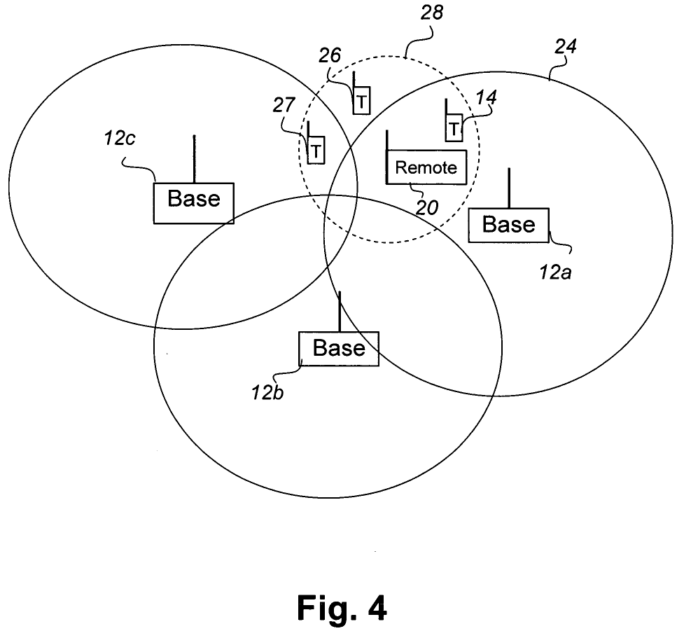

FIG. 4 illustrates a know interference situation in simplified form;

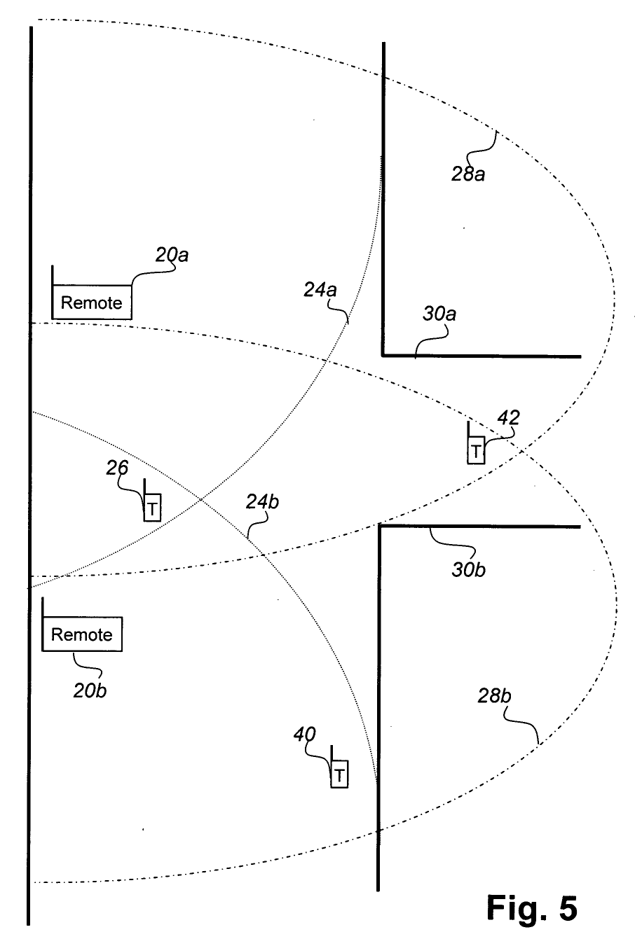

FIG. 5 illustrates a typical coverage situation in a wireless network; and

FIG. 6 illustrates a remote station in a wireless network in accordance with an embodiment of the present invention;

FIGS. 7a, 7b, 7c, 7d illustrate possible communications links between terminals and remote stations in accordance with embodiments of the present invention; and

FIG. 8 illustrates a method of providing increased bandwidth to a terminal using a remote station in accordance with an embodiment of the present invention.

### DETAILED DESCRIPTION OF THE PREFERRED EMBODIMENT

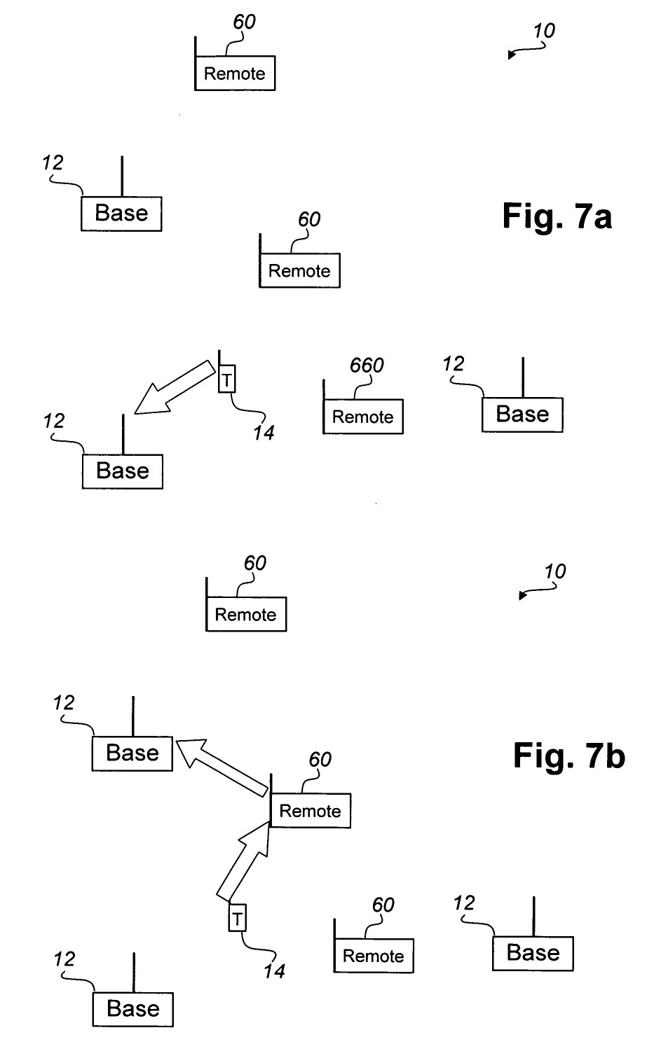

Referring to FIG. 6, there is illustrated a remote station in a wireless network in accordance with an embodiment of the present invention. Embodiments of the present invention allow for the easy construction of a remote station 60 that is a superset of a repeater. Unlike a repeater, the remote station 60 can associate with multiple base stations either serially or simultaneously. This association can be scheduled and coordinated to better optimize the air interface.

One way to construct such a remote station 60 is to connect a data terminal (i.e. data card) to a femtocell. The data terminal provides the access to the internet that the femtocell needs to be a remote station (or repeater). The remote station 60 can associate with multiple base stations 12 in scheduled and coordinated fashion. The scheduling and coordination can occur amongst the stations 12 nearby or by a centralized source. The remote station 60 would move traffic from one base station 12 to another as the error rates increase or as the traffic increase.

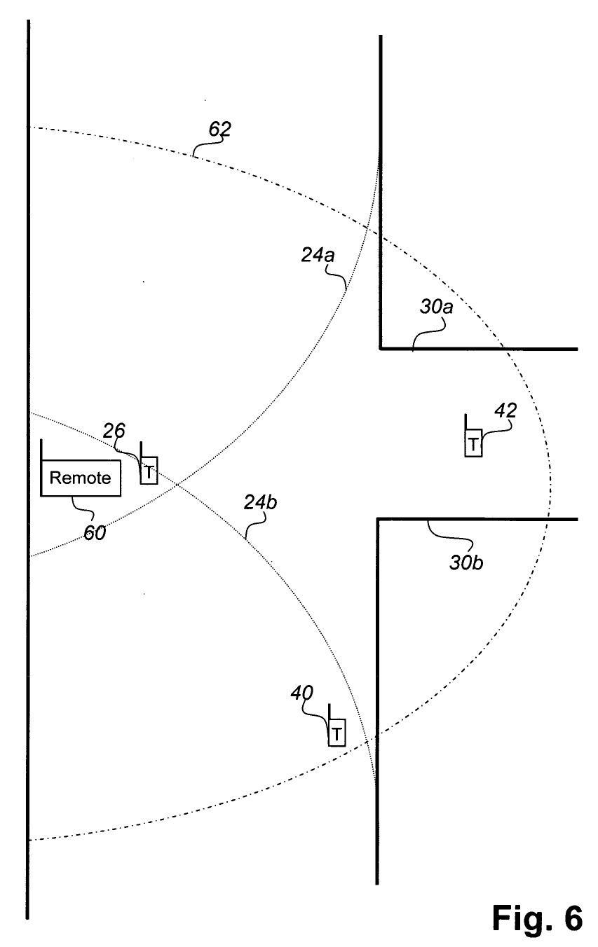

With the embodiment of FIG. 6, one remote station 60 is placed in the coverage 24a and 24b of both base stations 12a and 12b. This fills the coverage holes, allows for the previously out of coverage terminal 42 to receive coverage, and reduces the interference on the terminal 26 that previously had coverage. As an additional benefit, only one remote station 60 is needed. Also, both terminals 26 and 42 and a third terminal 40 have additional backhaul bandwidth that previously may not have been available. In the example of FIG. 5, the third terminal 40 would only have access to base station 12b backhaul. In the preferred embodiment, the third terminal 40 has access to the backhaul available to base station 12a and base station 12b as terminals 26 and 42 have gaps in transmission. The third terminal 40 can obtain to access the bandwidth available during the gaps in the transmissions with no lose of QOS to the two terminals 26 and 42.

In the centralized coordinated scenario, the remote stations 60 (and femto cells and base station 12) report to the centralized source (not shown in the figures) that makes the determination of which resources (codes, channels, frequencies) which station is to receive during which time interval. The allocation can be made as simple as a round robin to give each station all they need. The allocation can be made to be equal up to the bandwidth required by the station. The allocation can be made to give higher QOS to certain stations that are connected to terminal that paid for the higher QOS. The allocation can be made to give QOS to those in a certain class that “owns” the remote stations or provided remote stations on their property (since remote station are most likely deployed and maintained not by the carriers).

In the distributed scenario, the determination of the resources allocated to each station is determined by neighboring stations that are affected. The advantage of the distributed scenario is that the determination can be made faster to respond to the changes in the channel and the needs of the terminal. One possible method to coordinate will be the following:
The remote and base stations all determine their location with respect to one another. This can be done through GPS, triangulation, or a number of means.
The remote and base stations negotiate which resource it will use.
As the first remote station requires more resources, it communicates with its neighbors and request more resources. If the neighbors do not need the additional resources, they give the first remote station more resources until the neighbors need the resources back.

Furthermore, additional priority can be set as a function, but not limited to, service level, and QOS required by the application/service (RSS, FTP, HTTP, streaming, etc). For example. the owner of the remote terminal may have paid extra to guarantee a certain service. Since the spectrum is owned by the carrier, the carrier may optimize to give certain terminals priority. In an extreme case, the carrier can allow these terminals to utilize as much resources as required and starve the other terminal to the remainder. Realistically, the carrier would probably reserve a small amount of the resources to the other terminals, e.g. 10%, so these terminals get some QOS. Also, the carriers may give the terminals associated with certain remote stations higher priority and potentially higher priority even outside their home remote station. Furthermore, the carrier as part of the agreement may give certain business or emergency users higher QOS.

Another way to give priority would be by discriminating applications or services. Some services suffer more with a delay than others. Streaming applications and web surfing (HTTP) will effect the user performance more than other applications such as FTP, RSS, or email. A table can be created to prioritize certain services. A higher priority service is given a larger access to the resources. Realistically, a timer would be set so that a lower service is not unduly delayed. Also, realistically, part of the resources are reserved (e.g. 10%) to allow for the non-priority services.

Even without feedback, the communication between the stations can lead to a partial optimal solution since without the coordination, the stations can interfere with each other (i.e. Bayes Equilibrium).

In a deployment of a network, a remote station that can connect with more than one base station in a scheduled fashion. The remote station can be a remote base station/access point, relay station, range extender or any device that has the functionality of a remote station.

### EXAMPLE 1

A remote station is communicating with 2 base stations. It is scheduled to talk to the first base station for half the time and the second station half the time switching every time T. Also, for simplicity, say that there are 100 units that can be divided. At the beginning 50% of the time the remote station is communicating to the first base station and 50% of the time the remote station is communicating with the second base station. Also, the error rate on the link to the base station is higher than that with the second base station. Every 100 T units, the remote station will communicate one more unit time to the second base station and one less from the first base station until the error rate equalize. The scheduling can be such that is it even distributed (i.e. density modulated).

### EXAMPLE 2

A remote station is communicating with 1 base station. The terminal communicating with the remote station wants to increase the data rate. The, additional data rate is sent to the second base station. The scheduling can be such that is it even distributed (i.e. density modulated).

A wireless network has a remote station that can connect with more than one base station simultaneously. The remote station can be a remote base station/access point, relay station, range extender or any device that has the functionality of a remote station.

### EXAMPLE

A remote station is communicating with one base station. The terminal communicating with the remote station wants to increase the data rate. The additional data rate is sent to the second base station by remote station establishing a link to the second base station. The data sent to the second base station can be packet based or it can be service based (i.e. the new service all goes to the second base station).

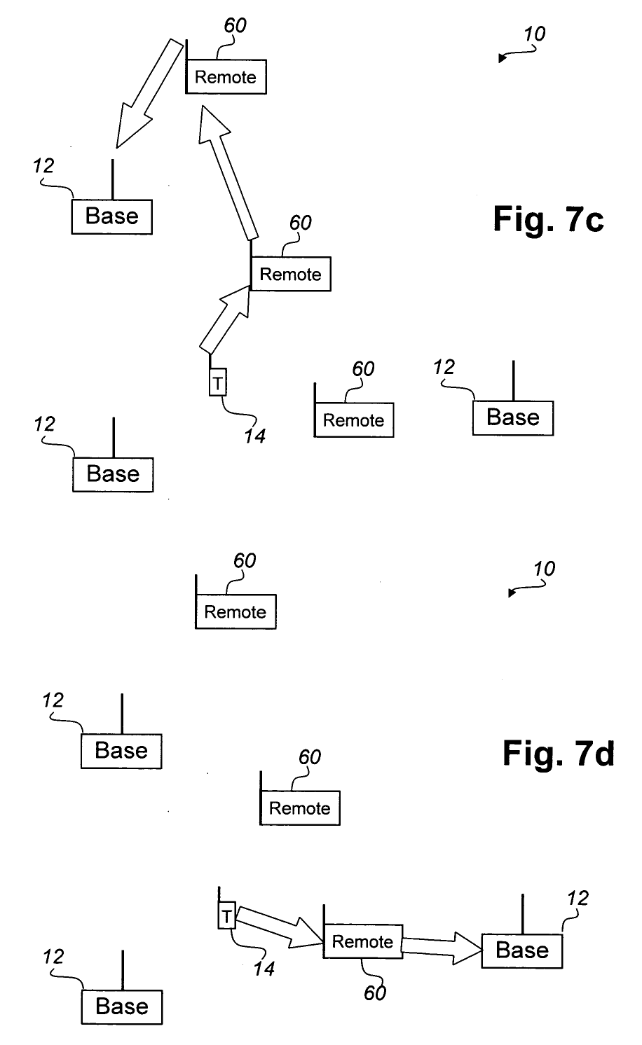

A remote station uses a different communication path with different time or different usage profiles. The different paths can lead to the same or a different base station. A path is the series of remote stations and base station that connect the terminal to the backhaul. A path could be as simple as a terminal to base station to a backhaul, as shown in FIG. 7a. Paths can be arbitrarily long: terminal to remote station, to remote station to base station, to backhaul, as shown in FIG. 7c. The remote station can be a remote base station/access point, relay station, range extender or any device that has the functionality of a remote station. Different usage profiles can constitute but is not limited to different times, different amount of data on the network, different number of terminals, different applications running on the network, or different QOS available to the terminals. FIGS. 7a-7d show different paths from a terminal to a base station with backhaul.

The above remote station may use a different path for up and downlink. A path is the series of remote stations and base station that connect the terminal to the backhaul. A path could be as simple as a terminal to base station to a backhaul. Paths can be arbitrarily long: terminal to remote station, to remote station, . . . , to base station, to backhaul.

The above remote station may use a different path scheduled at a certain time determined beforehand. The remote station can be a remote base station/access point, relay station, range extender or any device that has the functionality of a remote station.

The above remote station has the determination determined by a coordination of a plurality of remote stations or base stations.

The above remote station has the determination prescheduled and transmitted to the remote station.

The above remote station has the determination determined by a centralized source that coordinate a plurality of remote stations or base station with the data (either direct or indirect) from the remote station(s) or base station(s). The centralized control can be a base station controller or even a separate entity on the core network. The direct data can be RF measurements, error measurement, or alike from the remote station(s) and base station(s). The indirect data can be data inferred from the backhaul data to and from the remote station(s) and base station(s).

In another system, a remote station uses a technique at a different (i.e. scheduled) time to minimize interference or increase QOS. The techniques can include but are not limited to beam forming, sectoring, turning on/off antennas, moving antennas, shaping antennas, using different OFDM tones, or different timeslots. Furthermore, techniques can include changing downlink transmit power, coding rates, coding techniques, modulation order, length of cyclic prefix, symbol length (in OFDM). Furthermore, one can use multiple antenna techniques such as transmit diversity schemes. The schedule can be pre-determined or can be a function of data, QOS, number of user or alike. The remote station can be a remote base station/access point, relay station, range extender or any device that has the functionality of a remote station.

In the above other system, the schedule is negotiated by a plurality of remote station(s) and base station(s).

In the above other system, where the schedule is determined by a centralized source that coordinates a plurality or remote stations or base stations with the data (either direct or indirect) from the remote station(s) or base station(s). The centralized source can be a base station controller or even a separate entity on the core network. The direct data can be RF measurements, error measurement, or alike from the remote station(s) and base station(s). The indirect data can be data inferred from the backhaul data to and from the remote station(s) and base station(s).

A remote station (the first station) where the first station is connected to more than one remote station or base station to provide diversity to/from the first station. The remote station can be a remote base station/access point, relay station, range extender or any device that has the functionality of a remote station.

For example, there is a remote station 60 that can connect to two base stations (base station A and base station B). The channel conditions are such that the remote station 60 can communicate to base station A with a data rate of X. The channel conditions are such that the remote station can communicate to base station B with a data rate of Y. The terminal(s) which is/are communicating to the remote station wishes to utilize a data rate of Z such that Z>X and Z>Y and Z<=X+Y. The channel conditions are such that the terminal(s) and the remote station can communicate at least a data rate of Z.

The remote station sends part of the backhaul traffic to base station A and another part of the data to base station B such that the effective data rate is Z. The terminal(s) now can utilize a data rate of Z which is higher than X and Y

In another example, there is a remote station that connects to 2 base stations (base station A and base station B). The channel conditions are such that the remote station can communicate to base station A with a data rate of X. The channel conditions are such that the remote station can communicate to base station B with the data rate of Y. The terminal C which is communicating to the remote station wishes to utilize a data rate of Z. Also, there is another terminal D that is also communicating with base station A at a data rate of K. The data rates are such that Z+K>X.

The remote station sends part of the traffic from the terminal C to base station A and another part of the data to base station B such that the sum of the total is Z. Also, the remote station sends the data such that the total data rate going to base station A does not exceed X even when the data rate of K from terminal C is included.

A remote station (the first station) where the first station is connected to a more than one of remote station(s) or base station(s) to provide added a higher data rate at that time versus what would have been available with only one remote station or base station. The remote station (i.e. not the first station) if used all terminate a base station. The multiple paths available to the first station terminate at multiple base station to provide the added backhaul capability. The remote station can be a remote base station/access point, relay station, range extender or any device that has the functionality of a remote station.

For example, there is a remote station that can connect to 2 base stations: base station A and base station B. The backhaul available at base station A is a data rate of X. The backhaul available at base station B is a data rate of Y. The terminal(s) which is/are communicating to the remote station wishes to utilize a data rate of Z such that Z>X and Z>Y and Z<=X+Y. The channel conditions are such that the terminal(s) and the remote station can communicate at least a data rate of Z.

The remote station sends part of the traffic from the terminal to base station A and another part of the data to base station B such that the sum of the total is Z. The terminal(s) now can utilize a data rate of Z which is higher than X and Y

In another example, there is a remote station than connects to 2 base stations (base station A and base station B). The backhaul available at base station A is data rate of X. The backhaul available at base station B is a data rate Y. The terminal C which is communicating to the remote station wishes to utilize a data rate of Z and the channel between terminal C and the remote station can support this rate. Also, there is another terminal D that is also communicating with base station A at a data rate of K. Also, there is sufficient channel to support this. The data rates are such that Z+K>X.

The remote station sends part of the traffic from the terminal C to base station A and another part of the data to base station B such that the sum of the total data rate is Z. Also, the remote station sends the data such that the total data going to base station A does not exceed X even when the data rate of K from terminal C is included.

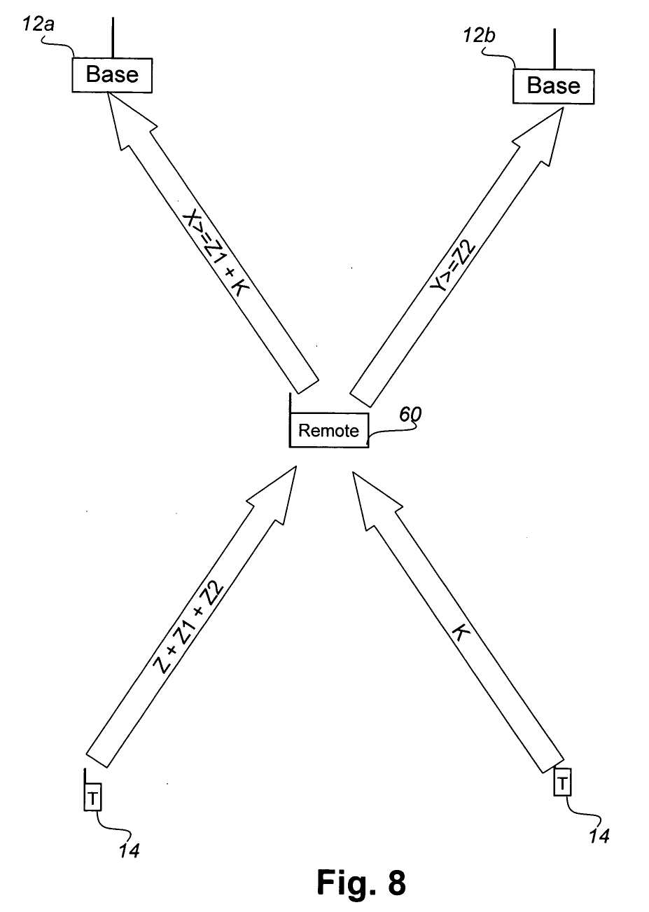

Referring to FIG. 8, there is illustrated a method of providing increased bandwidth to a terminal using a remote station in accordance with an embodiment of the present invention

The remote station above uses the in-band or out-of-band signaling to increase QOS.

For example, if the terminal was communicating to the remote station using LTE (Long Term Evolution), the remote station can use GSM SMS to coordinate the need of the remote station to the other remote station(s)/base station(s) to increase the QOS of the terminal. This is an example using out-of-band signaling.

For example, if the terminal was communicating to the remote station using LTE, the remote station can send/receive data via GSM SMS to coordinate the need of the remote station through a centralized control that will determine the coordination needed to increase QOS. This is an example using out-of-band signaling.

For example, if the terminal was communicating to the remote station using LTE, the remote station can send signal through the LTE air interface to coordinate the need of the remote station to the other remote station(s)/base station(s) to increase the QOS of the terminal. This is an example using in-band signaling.

For example, if the terminal was communicating to the remote station using LTE, the remote station can use LTE to coordinate the need of the remote station through a centralized control that will determine the coordination needed to increase QOS. This is an example using in-band signaling.

The remote station above uses the in-band or out-of-band signaling to manage interference.

For example, if the terminal was communicating to the remote station using LTE, the remote station can send/receive data via GSM SMS to coordinate the need of the remote station to the other remote station(s)/base station(s) to minimize the interference. This is an example using out-of-band signaling.

For example, if the terminal was communicating to the remote station using LTE, the remote station can send/receive data via GSM SMS to coordinate the need of the remote station through a centralized control that will determine the coordination needed to manage interference. This is an example using out-of-band signaling.

For example, if the terminal was communicating to the remote station using LTE, the remote station can use LTE to coordinate the need of the remote station to the other remote station(s)/base station(s) to minimize the interference. This is an example using in-band signaling.

For example, if the terminal was communicating to the remote station using LTE, the remote station can use LTE to coordinate the need of the remote station through a centralized control that will determine the coordination needed to minimize the interference. This is an example using in-band signaling.

The remote station described above uses a reconfigurable radio to use the same resources on the out-of-band communication scheme.

For example, the remote station would send data through the LTE air interface to the terminal. Then it would reconfigure all or part of the radio to send/receive data via GSM SMS to coordinate with the other remote station(s)/base station(s) or a centralized control.

The remote station described above uses a reconfigurable radio to use the same resource on the in-band communication scheme.

For example, in the second example in claim 10, the remote station would send/receive data through the LTE air interface to the terminal. Then it would reconfigure all or part of the radio to utilize the LTE air interface to coordinate with the other remote station(s)/base station(s). Though the message(s) is/are in-band to LTE, the remote station may have to change bands for receiving and transmitting for communicating to coordinate versus communicating with the terminal since the uplink and the downlink for communicating to the remote station/base station and the terminal are reverse of that of communicating with the terminal.

The remote station described above uses a reconfigurable radio to use the same resources on the out-of-band communication scheme.

For example, the remote station would communicate LTE to the terminal. Then it would reconfigure all or part of the radio to communicate GSM SMS to coordinate with the other remote station(s)/base station(s) or with the centralized control.

The remote station described above uses a reconfigurable radio to use the same resource on the in-band communication scheme.

For example, the remote station would send/receive data through the LTE air interface to the terminal. Then it would reconfigure all or part of the radio to send/receive data through the LTE air interface to coordinate with the other remote station(s)/base station(s). Though the message(s) is/are in-band to LTE, the remote station may have to change bands for receiving and transmitting for communicating to coordinate versus communicating with the terminal since the uplink and the downlink for communicating to the remote station/base station and the terminal are reverse of that of communicating with the terminal.

A remote station which includes a base station directly connected to a terminal to provide the backhaul services.

Numerous modifications, variations and adaptations may be made to the particular embodiments described above without departing from the scope patent disclosure, which is defined in the claims.

What is claimed is:

1. A remote station for communicating with more than one base station comprising:
a first transceiver communicating with a terminal;
a second transceiver having first and second communication modes for communicating with two base stations;
means for changing the second transceiver between the first, second modes in dependence upon on a schedule; and
a schedule based upon at least one of error rates measured, signal and noise, interference measurements, and capacity available.

2. A remote station as claimed in claim 1 wherein the means for changing is a switch.

3. A remote station as claimed in claim 1 wherein the means for changing is a multiplexor.

4. A remote station as claimed in claim 1 wherein the schedule is predetermined.

5. A remote station as claimed in claim 1 wherein the schedule is determined centrally within a network.

6. A remote station as claimed in claim 1 wherein the schedule is determined locally by negotiation between one of a base and a plurality of remote stations, a plurality of base stations and a plurality of remote stations, and a plurality of remote stations.

7. A wireless system comprising:
a first base station;
a second base station;
a remote station capable of communicating with one of the first base station, the second base station and both first and second base stations; and
a wireless terminal coupled to the remote station for communication with one of the first base station, the second base station and both first and second base stations.

8. A wireless system as claimed in claim 7 wherein the remote station includes a switch for switching communication between the first and second base stations.

9. A wireless system as claimed in claim 7 wherein the remote station includes a multiplexor for switching communication between the first and second base stations.

10. A wireless system as claimed in claim 7 wherein the schedule is predetermined.

11. A wireless system as claimed in claim 7 wherein the schedule is determined centrally within a network.

12. A wireless system as claimed in claim 7 wherein the schedule is determined locally by negotiation between one of a base and a plurality of remote stations, a plurality of base stations and a plurality of remote stations, and a plurality of remote stations.

13. A method of communicating with a wireless terminal in a wireless network comprising the steps of;
establishing primary coverage by deploying a first plurality of base stations;
expanding primary coverage into secondary coverage by deploying a second plurality of remote stations, at least one remote station capable of communicating with at least two of the base stations;
the at least one remote stations providing enhanced service to a wireless terminal by coupling to one or more of the base stations in dependent upon a schedule.

14. A method of communicating with a wireless terminal in a wireless network as claimed in claim 13 wherein the schedule is predetermined.

15. A method of communicating with a wireless terminal in a wireless network as claimed in claim 13 wherein the schedule is determined centrally within a network.

16. A method of communicating with a wireless terminal in a wireless network as claimed in claim 13 wherein the schedule is determined locally by negotiation between one of a base and a plurality of remote stations, a plurality of base stations and a plurality of remote stations, and a plurality of remote stations.

17. A method of communicating with a wireless terminal in a wireless network as claimed in claim 13 wherein coupling includes a direct wireless link between the one of the remote stations and two of the base stations.

18. A method of communicating with a wireless terminal in a wireless network as claimed in claim 13 wherein coupling includes a wireless link via another of the remote stations.

19. A method of communicating with a wireless terminal in a wireless network as claimed in claim 13 wherein coupling includes a plurality of wireless links via a plurality of the remote stations.
